(19) United States
(12) Patent Application Publication
(10) Pub. No.: US 2024/0158996 A1
(43) Pub. Date: May 16, 2024

(54) Spiral Metal-bar Grate with Center Axle

(71) Applicant: William Edward Luedtke, Ocean Grove, NJ (US)

(72) Inventor: William Edward Luedtke, Ocean Grove, NJ (US)

(21) Appl. No.: 18/054,718

(22) Filed: Nov. 11, 2022

Related U.S. Application Data
(60) Provisional application No. 63/301,384, filed on Jan. 20, 2022.

(51) Int. Cl. E01C 9/00; E03F 5/06; H02K 7/18

(52) U.S. Cl. CPC E01C 9/007; E03F 5/06; H02K 7/1853

(57) ABSTRACT

Spiral metal-bar grate with a center axle that by utilizing ball-bearings on each end of the axle is attached to a metal/concrete/hard plastic and/or rubber framework of a stationary and permanent base that can be embedded in a “roadway” or affixed to the surface (with a ramp to enter and exit) that allows the metal-bar grate and axle to spin when contacted by the rotating tires of a vehicle passing over the grate; the apparatus's axle continuing through the ball-bearing framework is attached to an electric generator thus providing the necessary “motion” to turn the axle (utilizing the friction of the vehicle's tires and momentum of the moving vehicle) and generate electricity.

This is a Non-provisional Utility patent application claiming the benefit of Provisional Utility Patent application No. 63/301,384 EFS ID #44795923 filed Jan. 20, 2022.

### BACKGROUND OF THE INVENTION

### 1. Field of the Invention

This invention relates to a spiral metal-bar grate with a center axle. More specifically, the invention relates to a spiral metal-bar grate with (affixed to) a center axle that is attached to a base on both ends utilizing “ball-bearing” connections similar to a vehicle “wheel-hub” that allows it to spin; the apparatus of the invention is extremely durable to the extent that vehicles can drive over it and the upper-most section (one or two bars) is exposed to the point that friction from contact with a moving vehicles' tires turns the “spindle” and its axle and the axle that extends beyond the bearings is attached to a generator to produce electricity.

### 2. Description of the Prior Art

The concept of providing force, more specifically motion to generate electricity from a spinning axle for example, a wind-mill, water-wheel and/or hydro-plant and turbine are not new and available and widely used. Historically, wind-mills utilize blades to capture the wind, water-wheels and hydro-plants utilize flowing rivers, and although relatively efficient they are dependent on nature. However, they are very expensive to construct and can pose a danger to the environment. Secondly, in today's hybrid and electric vehicles, small generators within the vehicle are utilized to offset fuel efficiency but they are small in scale, inefficient, and costly as this technology requires all vehicles to each have their own generator; the idea of millions of vehicles driving around with their own power source is obviously not efficient and also requires an alternative source of power. Thirdly, the construction of a “metal-bar grate” is not new, for example, they are currently and commonly constructed (utilizing rebar) to cover rain-water ditches (especially in a dirt road/driveway for i.e. Central America) enabling vehicles to pass over the ditch. They are constructed in roadways and driveways and thus are sturdy and durable however unlike the invention they are linear in design and stationary. The configuration and construction of the invention, although utilizing similar materials and design, is spherical i.e. a spindle onto an axle and this configuration is not currently utilized.

Additionally, vehicles in motion in order to reach a desired destination and the cost of fuel or energy to do so are accepted and understood. Millions of vehicles are driving to desired destinations constantly every day and consuming extreme amounts of energy to do so. It seems apparent and desirable to harness the “force” expelled from each moving vehicle that is generated by the motion of its rotating wheels. To date, there is nothing on the market that attempts to harness this force. Also it would appear to be evident to someone most knowledgeable in the field that to generate electricity from a generator installed in each moving vehicle is not feasible; the idea of millions of vehicles (cars, etc.) traveling to their destinations with a generator to make use of the motion is prohibitive and not efficient. Also, the idea of generating enough electricity to surpass the amount of energy consumed for example, a stationary “vehicle” functioning solely to generate electricity by utilizing its spinning wheels is not feasible or productive as the energy consumed will always exceed that which is generated and therefore be worthless.

### SUMMARY OF THE INVENTION

As noted, none of the prior art i.e. “axle-spinning” apparatus (wind-mills, water-wheels and hydro-plants) or linear grates addresses the problem of harnessing the force created by the motion of rotating wheels of moving vehicles to turn an electric generator. This potential source of energy is currently being ignored. The present invention provides a “spiral metal-bar grate with axle” that is durable and sturdy enough to support a vehicle (auto) in motion passing over it (and the supporting base) thus allowing it to be spun by the friction from the moving vehicles' tires. The configuration places one to two bars (at any given moment) equal to or slightly elevated above the road surface so that it is contacted by the vehicle tires while the complete apparatus is installed in a “conduit-like” base either below a roadway surface or affixed on top. Basically it's constructed so that the exposed bars are in effect level with the “road” allowing the vehicle to drive over the invention (metal-bar grate spindle set on a wheel-hub like base on both ends allowing it to spin freely and thus turn the generator) with the friction from contact with the tires causing the spindle to turn while the inertia of the moving vehicle maintains its momentum: it is not always necessary for the vehicle to be “accelerating” to turn the metal-bar grate spindle and axle.

In addition, it should be apparent that the “metal-bar grate” apparatus can be constructed within a base, for example, a reinforced cement (and/or metal, hard plastic, rubber) box with similar functionality as stated above that is independent from but affixed to the top of a roadway surface utilizing a gradual ramp style construction similar to a speed bump where the vehicles could drive up and over the apparatus. This self-contained apparatus would even lend itself to be a “portable” unit that could be moved to locations as traffic volume dictates.

Again, as a person familiar with the art of electricity generation would realize there is a desire and need to harness any source of “motion-generated” force in order to generate electricity, more specifically in this case with the invention, the motion of vehicles' wheels (tires). People drive vehicles and currently this process consumes energy and fuel (electricity or gas) but little to generate energy from the motion. This resulting motion can and should be harnessed as a by-product of the motion of vehicles to generate electricity “in the process of travel” by passing over the “metal-bar” grate with axle and the subject of this invention, thus spinning the “grate” (and axle) from the friction of the wheels, and turning the turbine/generator much like any “wind-mill”, water-wheel, hydro-plant, etc. A key point of the invention is the force is dependable and can be regulated especially if the spherical “metal-bar grate with axle” is located in a typically heavy traffic roadway area. For example, each vehicle passing over the “spindle grate” would turn it during the very brief moment it is in contact with it (spindle and axle) creating the force to power the generator similar to a wind-mill or water-wheel but unlike these various sources utilized in today's environment, this can be dependable and relatively constant and can be monitored and regulated unlike other sources that are dependent on nature. Also, the “source” of this power is a desirable condition that people are willing (and do) pay for in order to travel to a destination and the generation of electricity would be viewed as a secondary by-product.

To date, there is no known application to harness and utilize the motion of rotating tires of vehicles as they travel to desired destinations on roadways via a mechanism, in this case a “spiral metal-bar grate with axle” and the subject of this invention, to generate the force needed to spin an axle to turn a generator and produce electricity. This would be repeated by the millions of vehicles already in motion every second of every minute of every day in desired movement to a destination. Plus a huge benefit is the stationary position of the apparatus would allow for the storage of energy i.e. batteries or a connection to the “grid” that would not be feasible by generators manufactured inside individual (moving) vehicles. Also, it seems it would allow EV (electric vehicle) re-charging stations to be established next to the “metal-bar grate” roadway areas to directly benefit and utilize the electricity generated “at the roadway” to recharge immediately thusly extending EV range and reducing the size and complexity of necessary storage capabilities of batteries adding to the simplicity and sustainability. The term “at the roadway” implies any road surface and it's conceivable that with the acceptance of the “metal-bar grate”, areas along established routes could be constructed similar to a ramp or rest stop or HOV lane where a certain (and/or necessary for optimal motion and electric generation) speed is maintained while continuing in the desired direction. It's also conceivable that an electronic payment system similar to tolls booths could be established to reward cooperating drivers.

The simplicity of the invention is easily apparent which testifies to its uniqueness. It succeeds where other axle sources of motion fail; it is not dependent on an unpredictable and non-manageable source of nature, for example, the wind or a river to turn the axle. It can be constructed and/or employed in any “roadway” where desired, particularly where there is a steady flow of traffic. Plus it adds to the “sustainability” of vehicular motion as the vehicle itself is used to generate electricity that can ultimately recharge the vehicle. This generation of electricity is a by-product of the already desired outcome of movement of the vehicle. While the energy consumed by the moving vehicle exceeds the energy generated, ultimately it seems conceivable for all vehicular movement to be “sustainable” with the addition of a secondary source of “sustainable” electricity i.e. the use of solar, wind, and/or hydro generated electricity combined with the “metal-bar grate with axle” generated energy, possibly eliminating the need for fossil fuels. No invention to date has been able to capture all the key factors of the “spiral metal-bar grate” with a center axle.

### BRIEF DESCRIPTION OF THE DRAWINGS

FIG. 1 is a perspective view of a device constructed according to the present invention.

FIG. 2 is a top side view of the device on line 8-8 of FIG. 1

### DESCRIPTION OF THE PREFERRED EMBODIMENT OF THE INVENTION

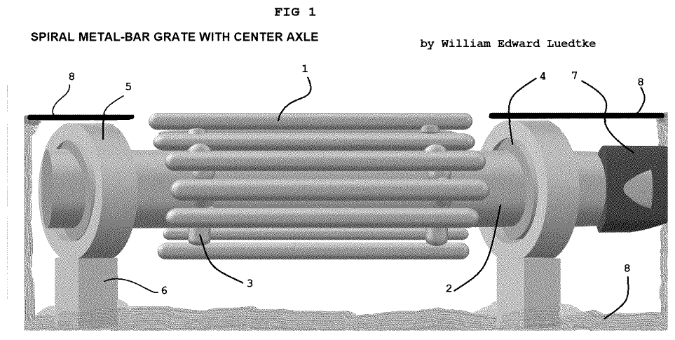

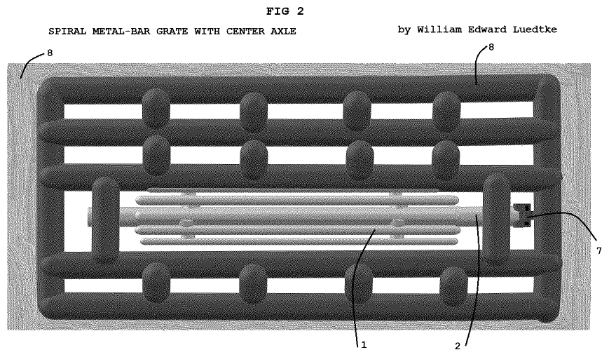

The unique spiral metal-bar grate with center axle according to the present invention, how it performs, how it differs or is unique from previous inventions, and the advantages over the prior art devices (if any) becomes apparent by reference to the attached drawings. FIG. 1 illustrates the preferred embodiment of the spiral metal-bar grate with center axle with ball-bearings on each end of the axle allowing it to spin that is attached and supported by a stationary base of metal and concrete (similar to a drainage grate configuration widely used today). FIG. 2 illustrates the apparatus of the invention being supported by a metal linear “grate” and concrete base similar to a drainage grate.

Referring to FIG. 1 the device of the invention has three parts 1, 2 and 6 that basically represent one apparatus as they are affixed to each other and work in conjunction with each other. While the size of each part can vary as can the material used in its construction, the length of part 1 in the preferred embodiment is 3 feet. The 3 foot length provides sufficient distance for a moving vehicle to pass over it providing a comfort level to assure contact (a typical tire is less than 1 foot wide so it can thus accommodate larger tires of trucks, etc.). The diameter of part 1 the grate is 12 inches that will expose enough metal-bars while spinning to assure 1 or 2 bars are always level with or slightly above the road surface for contact and spun by motion and friction of the rotating tires. Providing the mechanism to support the metal-bar grate part 3 affixes the bars to the axle part 2 and the axle attaches to a generator part 7. The axle part 2 is 4 feet in length thus extending beyond the length of the metal-bars part 1 providing the clearance for the grate part 1 to spin unimpeded, while the axle part 2 is being supported by the base parts 6 and 8 via ball-bearings parts 4 and 5 also reflected in FIG. 1. The diameter of the axle part 2 in the preferred embodiment is 2 inches but can be any diameter as necessary depending on the materials used and the size of the total apparatus of a specific application. The metal bars part 1 are typically 0.5 inches in diameter as in a standard rebar and the spiral “grate” incorporates 18 bars approximately 2 inches apart (but can vary as needed).

Referring to FIG. 2 is a top side perspective of the preferred embodiment reflecting a linear metal grate part 8 very similar to that of a standard roadside drainage grate however in the infrastructure supporting the invention (spiral “metal-bar” grate with axle) there is a space in the center of 5 inches which is enough space (in the road surface) for 2 bars part 1 to be exposed. The steel framework part 8 is 20 inches wide with approximately 7 inches on each side of the opening and 20 inches deep providing the necessary clearance for the spiral grate part 1 and 2 as in in FIG. 1 and the concrete box is at least 5 feet in length to accommodate the full length of the axle part 2. All of the other parts 2, 3, 4, 5, and remaining 16 bars part 1 are below the “road” surface (i.e. the actual roadway surface in the case of the apparatus being installed below the road via a dugout area) or the top surface of a constructed metal, concrete, hard plastic and/or hard rubber “box” with entry and exit ramps similar for perspective sake, to a “speed bump”.

Having thus described the invention in a preferred embodiment, it is to be understood that the invention is not limited to the embodiment set forth herein and that various modifications and revisions can be made to the embodiment as shown without deviating from the intent and scope of the invention. It is the intention, however, that all such modifications and revisions as are obvious to those skilled in the art will be included within the scope of the claims (including but not limited to even the elimination of the “metal-bar grate” with sole usage of an axle; the metal-bar grate facilitates the process).

I claim:

1. A spiral metal-bar grate with center axle apparatus that is approximately twelve inches in diameter and three feet in length with, for example, eighteen bars (rebar) all affixed to the center axle that is affixed to the base utilizing “ball-bearing” wheel hub type connections on each end that allows the metal-bar grate and thus the axle to spin on contact with rotating tires of vehicles passing over the grate that is established in or above a roadway. The spindle can be of various lengths, for example, as mentioned three feet since only one tire needs to be in contact. The inertia and momentum of the vehicle will keep it in motion while forcing the wheels to turn and thereby turning the metal-bar grate and axle to the generator. The base of the apparatus is/can be similar in construction to a drainage ditch grate already commonly used but rather than the total grate being one piece resting on top of the concrete base and linear in design, the metal-bar grate with axle apparatus and subject of the invention is separate from the “base” grate that has an opening from which the spherical grate extends allowing it to spin freely when passed over by a vehicle's tires.

2. Any apparatus or mechanism utilizing similar technology whereby it is established within or above a roadway so that the motion and friction of rotating vehicles' wheels (tires) moving and passing over it exert the force required to spin an axle that is affixed to a generator to create electricity or other desired outcome. The stationary nature and simple construction of the “base” and “metal-bar grate with center axle” apparatus allows for the construction and/or placement (in the case of a prefabricated “unit”) of the apparatus in and near the “roadway” where there is “traffic” and thusly the necessary movement over the apparatus of vehicles to desired locations. This also enables the storage of electricity in large scale backup systems i.e. batteries or connection to the “grid” verses and unlike within individual vehicles where the inclusion of large scale generators and batteries or attachment to the “grid” is not feasible or possible as they are heavy and the space within a single vehicle does not accommodate the required infrastructure and the movement prohibits connection to “the grid”. As such, it is also feasible that EV (electric vehicle) re-charging stations could be established next to the “metal-bar grate” areas of the roadway to directly benefit from and utilize the electricity generated immediately also reducing the storage capacity of required batteries, thusly minimizing complex infrastructure and maintaining simplicity and efficiencies while supporting sustainability.
